(19) United States
(12) Patent Application Publication
(10) Pub. No.: US 2006/0265431 A1
(43) Pub. Date: Nov. 23, 2006

(54) Information processing system, replication method, difference information holding apparatus and program

(75) Inventors: Junichi Yamato, Tokyo (JP); Yuji Kaneko, Tokyo (JP); Masaki Kan, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/435,811

(22) Filed: May 18, 2006

(30) Foreign Application Priority Data
May 19, 2005 (JP) 2005-146810

(51) Int. Cl. G06F 17/30

(52) U.S. Cl. 707/201

(57) ABSTRACT

Disclosed is a replication system which includes non-adjacent difference information holding unit placed at a location other than that of the intermediate device. Among updates that have been performed in a storage unit on a normal channel, an update not yet reflected to a storage unit on a standby channel is recorded in the non-adjacent difference information holding unit.

### FIELD OF THE INVENTION

This invention relates to an information processing system and, more particularly, to a system, method, apparatus and computer program for executing replication whereby data is replicated synchronously among a plurality of storage units.

### BACKGROUND OF THE INVENTION

Computer systems equipped with a normal channel (also referred to as a “working channel” or “main channel” and a standby channel (also referred to as a “spare channel” or “backup channel”) in order that operation will continue even in the event of a disaster or the like have long been used. Such a computer system is referred to as a “replication system”. By way of example, usually the normal-channel system (site) operates to provide a system function. When the normal-channel site cannot function normally, the standby-channel system (site) operates instead of the normal-channel site.

In order to provide the functions of a computer system, the normal site and the standby site each have a storage unit for storing data. A replication system is such that the data in the storage unit of the normal site is duplicated and held in the storage unit of the standby site in such a manner that the standby site can operate instead of the normal site. Processing for such transfer and duplication between the sites of both channels is referred to as “replication”.

Replication systems are classified into synchronous replication and asynchronous replication systems depending upon how normal (operation) and standby sites are updated.

Synchronous replication is such that when data is written to the storage unit of the normal site, this is taken as an opportunity to write the same data to the storage unit of the standby site. After the writing of data has been applied to the storage units of both the normal and standby channels, a response to the write operation is sent back to the host of the normal site.

On the other hand, asynchronous replication is such that at the stage where data has been written to the storage unit of the normal site, a response is sent back to the host and the writing of data to the storage unit of the standby site is performed at any separate timing.

The following can occur in a replication system:

instances where the synchronization between the storage unit of the normal site and the storage unit of the standby site is lost temporarily (i.e., instances where the two become desynchronized); and

situations where the data in the storage unit of the normal site and that in the storage unit of the standby site do not match before an update is transferred in asynchronous replication.

Even under these conditions the data in the storage unit of the channel that is operating is updated and synchronization error during this time is ascertained by recording the update location or update content. When both channels (the storage unit of the normal site and that of the standby site) are reconnected, the loss in synchronization is grasped by the above-mentioned recording, the content of the update is sent from the updated channel to the other channel and the data can be restored to the synchronized state with the optimum amount of data transfer.

Replication systems include serially coupled replication systems having configurations in which an intermediate device is placed between a normal site and a standby site, examples of which include:

a configuration in which a storage unit is placed between a normal site and a standby site (see Non-Patent Document 1); and

a configuration in which a relay device is placed between a normal site and a standby site (see Patent Document 1).

Data update performed in the storage unit of the normal site is sent to the intermediate device, update of data sent to the intermediate device is sent from the intermediate device to the standby site, and data update is applied to the storage unit of the standby site, whereby the data in the storage unit of the normal site is duplicated in the storage unit of the standby site.

In a case where the normal site and intermediate device have been separated or the intermediate device and the standby site have been separated in a serially coupled replication system, a loss in synchronization between the separated elements of the combination (between the normal site and intermediate device or between the intermediate device and the standby site) can be ascertained.

In a serially coupled replication system, however, a loss in synchronization between devices that are not directly connected to each other cannot be ascertained. Consequently, if the intermediate device placed between a normal site and a standby site is lost owing to a disaster or the like (or if the intermediate device fails and ceases functioning), the two channels cannot be restored to a state in which the data between them agrees (the synchronized state) unless the normal site and standby site, which were not directly connected, copy all of the data.

[Patent Document 1]

Japanese Patent Application Kokai Publication No. JP-P2004-086721A

[Non-Patent Document 1]

EMC Corporation, EMC Symmetric Remote Data Facility: Multi-Hop Capability (Online) (Retrieved on Jan. 13, 2005), Internet <URL: http://www.emc.com/pdf/techlib/SRDF_multi_hop.pdf>

Thus, in the event that the intermediate device is lost in a serially coupled replication system, the synchronized state cannot be restored between the storage unit of the normal channel and the storage unit of the standby channel with a small amount of data transfer. The reason for this is that in replication, synchronization error can be recognized only between directly connected devices.

### SUMMARY OF THE DISCLOSURE

Accordingly, it is an object of the present invention to provide a system, method and program whereby a normal site and a standby site can be restored to the synchronized state even if an intermediate device is lost.

Another object of the present invention is to provide a system, method and program whereby a normal site and a standby site can be restored to the synchronized state, with only a small amount of data transfer, even if an intermediate device is lost.

According to one aspect of the present invention, the above and other objects are attained by providing an information processing system having first and second systems each provided with a storage unit, wherein replication is performed from the first system to the second system, the information processing system having difference information holding unit for holding difference information between data in the storage unit of the first system and data in the storage unit of the second system. In the present invention, replication is performed from the first system to the second system via an intermediate device. In the present invention, a corresponding relationship between update information sent from the first system and update information received by the second system is made freely discriminatable.

In relation to update performed with respect to the storage unit of the first system, the present invention may be so adapted that when update information is transmitted from the first system to the intermediate device, update-related information is recorded in the holding means, and when the second system has received the update information from the intermediate device, the update-related information corresponding to this update information is deleted from the holding means.

The present invention may be so adopted that after the second system has received a plurality of items of update information from the intermediate device, the update-related information corresponding to this update information is deleted from the holding means.

The present invention may be so adapted that data re-synchronization between the first and second systems is performed based upon the data mismatch information that has been recorded in the holding means.

A replication system in accordance with another aspect of the present invention, includes a first system having a storage unit and constituting a replication source, a second system having a storage unit and constituting a replication target, and an intermediate device provided between the first and second systems, the replication system comprising update information holding unit for recording update-related information of update information transmitted from the first system, and update-completed-information holding unit for recording update-related information of update information received by the second system.

Preferably, in the present invention, a corresponding relationship between update-related information recorded in the update information holding unit and update-completed information recorded by the update-completed-information holding unit is made freely determinable.

Preferably, in the present invention, re-synchronization of data between the first and second systems is performed based upon information, which is indicative of data synchronization error, generated from update-related information that has been recorded in the update information holding unit of the first system and update-completed information that has been recorded in the update-completed-information holding unit of the second system.

A replication system according to yet another aspect of the present invention, includes a first system having a storage unit and constituting a replication source, a second system having a storage unit and constituting a replication target, and an intermediate device provided between the first and second systems, wherein a corresponding relationship between update information sent from the first system and update information received by the second system is made freely discriminatable.

Preferably, in the present invention, in-transit update information is made freely specifiable from update information transmitted by the first system and update information received by the second system.

Preferably, in the present invention, data re-synchronization between the first and second systems is performed by re-sending update information that has been transmitted from the first system but not received by the second system.

According to another aspect of the present invention, the above and other objects are attained by providing a replication method in an information processing system including a first system having a storage unit, an intermediate device and a second system having a storage unit, wherein replication is performed from the first system to the second system via the intermediate device. Difference information holding unit is provided separately of the intermediate device, and the method includes having the difference information holding unit hold difference information between data in the storage unit of the first system and data in the storage unit of the second system.

According to another aspect of the present invention, there is provided a difference information holding apparatus arranged in an information processing system including a first system having a storage unit, an intermediate device and a second system having a storage unit, wherein replication is performed from the first system to the second system via the intermediate device, the apparatus comprising: means for holding difference information in which has been recorded the difference between an update performed in the storage unit of the first system and an update performed in the storage unit of the second system; and means for transferring update information, from among updates that have been performed in the storage unit of the first system, that is not yet reflected to the storage unit of the second system to the first system based upon the held difference information in response to a request from the first system when the intermediate device fails or is lost. The first system transfers not yet reflected update data to the second system without the intermediary of the intermediate device and updates the storage unit of the second system.

A computer program according to another aspect of the present invention, is the program for causing a computer to execute the following processing, the computer constituting a difference information holding apparatus provided in an information processing system including a first system having a storage unit, an intermediate device and a second system having a storage unit, wherein replication is performed from the first system to the second system via the intermediate device: processing for holding difference information in which has been recorded the difference between an update performed in the storage unit of the first system and an update performed in the storage unit of the second system; and processing for transferring update information, from among updates that have been performed in the storage unit of the first system, that is not yet reflected to the storage unit of the second system to the first system based upon the held difference information when the intermediate device fails or is lost.

The meritorious effects of the present invention are summarized as follows.

The present invention provides a number of effects, which will now be set forth.

In accordance with the present invention, a first effect is that synchronization error between normal and standby systems that are not directly connected can be recognized. The reason for this is that non-adjacent difference information holding unit holds non-adjacent difference information that specifies an update, which is not yet reflected to the storage unit of the standby system, among updates that have been performed in the storage unit of the normal system.

In accordance with the present invention, a second effect is that synchronization error between normal and standby systems that are not directly connected can be recognized. The reason for this is that in the present invention, identification information that can correlate update information held within the normal system and update-completed information held within the standby system is appended to update information sent from the normal system to the standby system via the intermediate device, and the information that has been appended is recorded in update information held within the normal system and in update-completed information held within the standby system.

In accordance with the present invention, a third effect is that synchronization error between normal and standby systems that are not directly connected can be recognized even if an intermediate device is lost. The reason for this is that in the present invention, the non-adjacent difference information holding unit is not lost at the same time as the intermediate device.

In accordance with the present invention, a fourth effect is that it is possible to ascertain the corresponding relationship between update items of update information sent between normal and standby systems that are not directly connected. The reason for this is that in the present invention, update information that arrives at the standby system is provided with appended identification information that indicates the correspondence between this information and update information that has been sent from the normal system.

In accordance with the present invention, a fifth effect is that synchronization error between normal and standby systems that are not directly connected can be recognized. The reason for this is that in the present invention, it is possible to ascertain update information that has not arrived at the standby system, among updates that have been sent from the normal system, owing to the fourth effect mentioned above.

In accordance with the present invention, a sixth effect is that the storage unit of the normal system and the storage system of the standby system can be placed in a synchronized state without the intermediary of an intermediate device. The reason for this is that in the present invention, update that is not yet reflected to the standby storage unit can be transferred from the normal storage unit using the first, second or fifth effect.

In accordance with the present invention, a seventh effect is that the storage unit of the normal system and the storage system of the standby system can be placed in a synchronized state even if the intermediate device is lost. The reason for this is that in the present invention, update that is not yet reflected to the standby storage unit can be transferred from the normal storage unit using the third effect.

In accordance with the present invention, an eighth effect is that it is possible to reduce amount of data transfer when the storage unit of the normal system and the storage system of the standby system are placed in the synchronized state after loss of the intermediate device. The reason for this is that in the present invention, only the amount of updated data necessary to correct synchronization error between the normal and standby systems is transferred owing to the first, second and fifth effect.

In accordance with the present invention, a ninth effect is that it is possible to shorten processing time when the storage unit of the normal system and the storage system of the standby system are placed in the synchronized state after loss of the intermediate device. The reason for this is that in the present invention, the amount of data transferred is reduced owing to the eighth effect.

In accordance with the present invention, a tenth effect is that it is possible to shorten the period of influence upon business processing by the normal system when the storage unit of the normal system and the storage system of the standby system are placed in the synchronized state after loss of the intermediate device. The reason for this is that in the present invention, the time needed to achieve the synchronized state can be shortened owing to the ninth effect.

In accordance with the present invention, an 11^{th} effect is that it is possible to shorten the duration of a decline in reliability of the system after loss of the intermediate device. The reason for this is that in the present invention, the period of time during which the storage unit of the normal system and the storage unit of the standby system are not in the synchronized state is shortened and, even if the storage unit of the normal system is lost, the period of time during which the latest data is stored in the storage unit of the standby system can be lengthened owing to the ninth effect.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the configuration of a first embodiment of the present invention;

FIG. 2 is a flowchart illustrating operation when replication master processing means involved in synchronous replication has received an access request from a host in the first embodiment;

FIG. 3 is a flowchart illustrating operation when replication master processing means of this embodiment involved in asynchronous replication has received an access request from a host in the first embodiment;

FIG. 4 is a flowchart illustrating operation when replication replica processing means has received update information from an intermediate device in the first embodiment;

FIG. 5 is a flowchart illustrating operation when non-adjacent difference information holding unit has been requested to delete update information by replication replica processing means of a standby system in the first embodiment;

FIG. 6 is a flowchart illustrating operation of replication master processing means in re-synchronization processing in the first embodiment;

FIG. 7 is a block diagram illustrating the configuration of a second embodiment of the present invention;

FIG. 8 is a flowchart illustrating operation when replication replica processing means has received update information from an intermediate device in the second embodiment; and

FIG. 9 is a flowchart illustrating operation of replication master processing means in re-synchronization processing in the second embodiment.

### PREFERRED EMBODIMENTS OF THE INVENTION

Preferred embodiments of the present invention will now be described in detail with reference to the accompanying drawings.

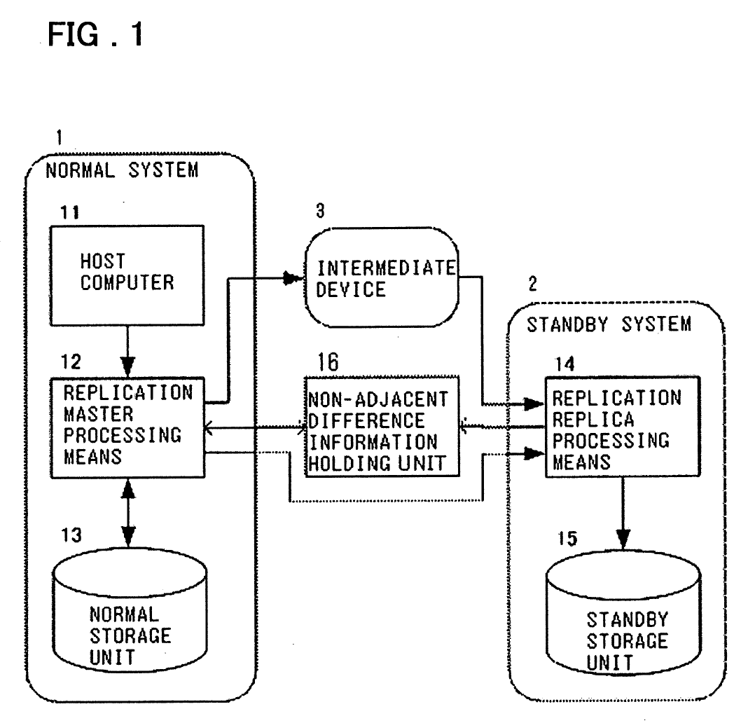

As shown in FIG. 1, an information processing system according to the present invention is provided with a non-adjacent difference information holding unit (16) at a location other than that of an intermediate device (3). Among updates that have been performed in a storage unit (13) of a normal-channel system (1) (this storage unit will also be referred to as a “normal storage unit”), non-adjacent difference information that specifies an update not yet reflected to a storage unit (15) of a standby-channel system (2) (this storage unit will also be referred to as a “standby storage unit”) is recorded in the non-adjacent difference information holding unit (16).

When the intermediate device (3) becomes unusable due to failure or the like or is lost as result of a disaster or the like, update information not yet reflected to the standby storage unit (15) in the normal storage unit (13) is transferred from the normal system (1) to the standby system (2) [the transfer is made without the intermediary of the intermediate device (3)] based upon non-adjacent difference information being held in the non-adjacent difference information holding unit (16), which is not disabled or lost at the same time as the intermediate device (3). In the standby system (2), the not yet reflected update data transferred from the normal system (1) is applied to the standby storage unit (15). In accordance with the present invention thus constructed, the normal system (1) and standby system (2) can be restored to the synchronized state rapidly even in the event that the intermediate device is lost due to a disaster or the like.

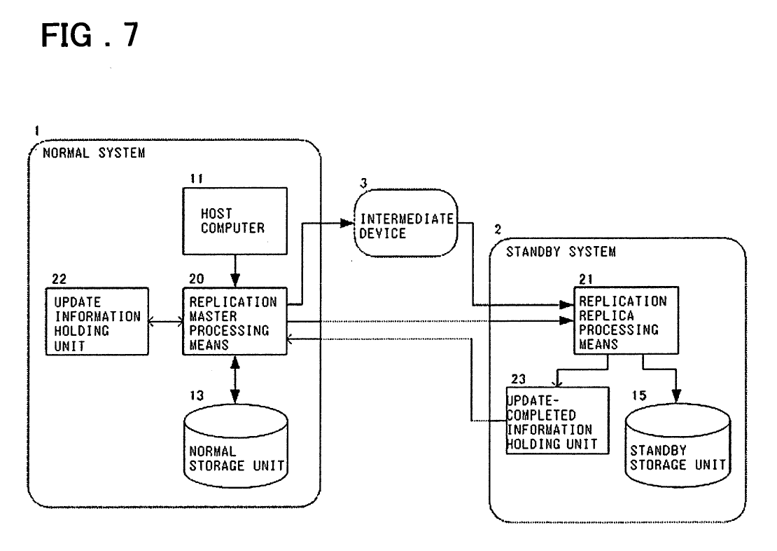

As shown in FIG. 7, a serial information processing system according to the present invention includes the normal system (1), which is equipped with an update information holding unit (22), and the standby system (2), which is equipped with an update-completed information holding unit (23). An update that has been performed in the normal storage unit (13) is recorded in the update information holding unit (22), and an update that has been sent from the intermediate device (3) and is reflected to the standby storage unit (15) is recorded in the update-completed information holding unit (23).

Further, identification information is appended to update information, which is sent from the normal system to the standby system via the intermediate device, so as to correlate the update recorded in the update information holding unit (22) and the update recorded in the update-completed information holding unit (23). In the event that the intermediate device (3) is lost, the contents of the update information holding unit (22) and the update-completed information holding unit (23) are compared. Among the updates that have been performed in the normal storage unit, an update not yet reflected to the standby storage unit is computed, the computed update is transferred from the normal storage unit to the standby system, and not yet reflected updated data that has been transferred is applied to the standby storage unit. As a result, even in the event that the intermediate device (3) is lost, the data at the normal site and the data at the standby site can be restored to the synchronized state by transfer of a small amount of data.

The serial-type information processing system according to the present invention has additional information for ascertaining the correspondence between update information received by the standby system and update information that has been sent by the normal system. In the event that the intermediate device is lost, the system computes an update, which is not yet reflected to the standby system, from among updates sent by the normal system, transfers the computed update from the normal storage unit to the standby system, and applies the transferred not-yet reflected updated data to the standby storage unit. As a result, even in the event that the intermediate device is lost, the data at the normal site and the data at the standby site can be restored to the synchronized state by transfer of a small amount of data.

Embodiments of the present invention will now be described.

FIG. 1 is a block diagram illustrating a system according to a first embodiment of the present invention.

As shown in FIG. 1, the system of the first embodiment includes a system 1 of a normal channel, a system 2 of a standby channel, an intermediate device 3 and a non-adjacent difference information holding unit 16.

The normal (operation) system 1 has a host computer 11 for executing processing, a normal storage unit 13 for holding data, and replication master processing means 12 for intervening in access to the normal storage unit 13 of the host computer 11 and executing replication processing on the side of the normal system 1.

The standby system 2 has a standby storage unit 15 for holding data, and replication replica processing means 14 for executing replication processing on the side of the standby system 2 and updating the data in the standby storage unit 15.

The replication master processing means 12 of normal system 1 and the replication replica processing means 14 of standby system 2 are connected to the intermediate device 3 by a network, etc.

Further, the replication master processing means 12 of normal system 1 and the replication replica processing means 14 of standby system 2 are connected to the non-adjacent difference information holding unit 16 by a network, etc.

Further, the replication master processing means 12 of normal system 1 and the replication replica processing means 14 of standby system 2 are connected to each other by a network, etc.

The replication master processing means 12 of normal system 1 intervenes in access to the normal storage unit 13 of the host computer 11, executes replication processing on the side of the normal system 1 and registers update-related information concerning data update performed in the normal storage unit 13 in the non-adjacent difference information holding unit 16. In a case where the normal storage unit 13 and standby storage unit 15 are placed in the synchronized state without the intermediary of the intermediate device 3, the replication master processing means 12 reads data out of the normal storage unit 13 and creates update information based upon non-adjacent difference information acquired from the non-adjacent difference information holding unit 16, and transmits the update information, which is for the purpose of re-synchronization, to the replication replica processing means 14 of standby system 2.

The replication replica processing means 14 of standby system 2 executes replication processing on the side of the standby system 2 based upon update information accepted from the intermediate device 3, and deletes updated-completed update-related information from the non-adjacent difference information holding unit 16 based upon the accepted update information. In a case where the normal storage unit 13 and standby storage unit 15 are placed in the synchronized state without the intermediary of the intermediate device 3, the replication replica processing means 14 updates the standby storage unit 15 based upon re-synchronization update information sent from the normal system 1.

The intermediate device 3 receives update information sent from the replication master processing means 12 of normal system 1 and, at an opportunity decided by the information processing system, transfers the received update information to the replication replica processing means 14 of standby system 2 based upon the accepted update information.

The non-adjacent difference information holding unit 16 has a storage device (not shown) that stores update-related information. If update-related information has been accepted from the replication master processing means 12 of normal system 1, the non-adjacent difference information holding unit 16 records and holds this information. Further, if updated-completed information has been accepted from the replication replica processing means 14 of standby system 2, then the non-adjacent difference information holding unit 16 retrieves the update-related information that corresponds to the accepted update-completed information and deletes this update-related information (update-related information accepted by the standby system 2) from update-related information held in the storage device.

Further, upon receiving a request from the replication master processing means 12 of normal system 1, the non-adjacent difference information holding unit 16 sends update-related information that has been recorded in the storage device (not shown) of the non-adjacent difference information holding unit 16 back to the replication master processing means 12 of normal system 1 as unapplied update-related information.

Each process in the non-adjacent difference information holding unit 16 can have its functions implemented by a computer program (an execution-format binary program) that operates on a computer that constitutes the non-adjacent difference information holding unit 16.

It should be noted that the node between a replication source and a replication target that construct the information processing system may be constituted by a server or may be a switch or the like placed between a server and storage units, or may be a storage unit.

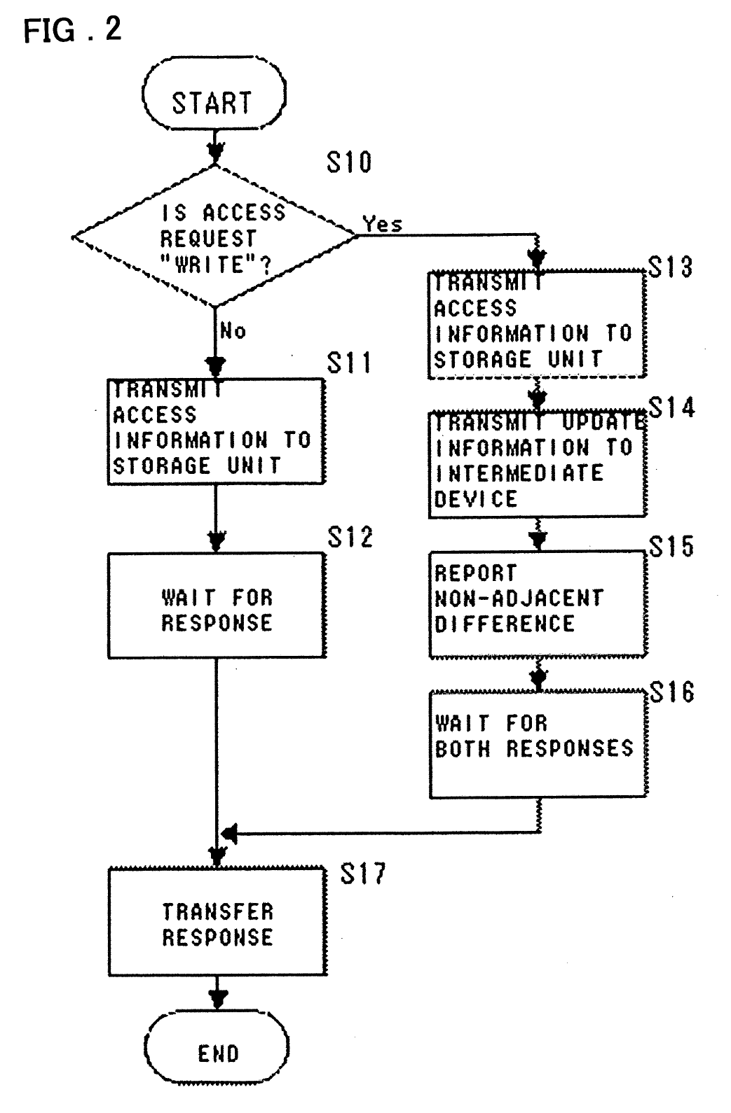

FIG. 2 is a flowchart illustrating processing according to this embodiment of the present invention. Replication processing according to this embodiment will be described with reference to FIGS. 1 and 2.

Described first will be operation when the replication master processing means 12 of this embodiment has received an access request from the host computer 11 in synchronous replication.

Upon receiving the access request from the host computer 11, the replication master processing means 12 determines whether the access requested is “write” (step S10). Control proceeds to step S11 if the request is not “write” and to step S13 if the request is “write”.

At step S11 (executed if the request is not “write”), the replication master processing means 12 transfers the accepted access request to the normal storage unit 13 and waits for a response from the normal storage unit 13 (step S12).

When a response from the normal storage unit 13 arrives at the replication master processing means 12, the latter advances processing to step S17, transfers the response that has arrived to the host computer 11 and quits processing.

At step S13 (executed if the request is “write”), the replication master processing means 12 transfers the access request to the normal storage unit 13.

Next, the replication master processing means 12 creates update information from the access request and transmits the update information to the intermediate device 3 (step S14).

Next, the replication master processing means 12 creates update-related information from the update information and requests the non-adjacent difference information holding unit 16 to register the update-related information that has been created (step S15).

Next, the replication master processing means 12 waits for responses from the intermediate device 3 and non-adjacent difference information holding unit 16 (step S16). When the responses arrive at the replication master processing means 12, control proceeds to step S17. Here the replication master processing means 12 transfers the responses that have arrived to the host computer 11 and quits processing.

Update information includes the following:
information for specifying the write-target location;
the write-target data; and
an identifier for identifying the update information.

Update-related information includes the following:
information for specifying the write-target location; and
an identifier for identifying the update information.

The identifier for identifying the update information in the update information and in the update-related information is generated by the replication master processing means 12, by way of example.

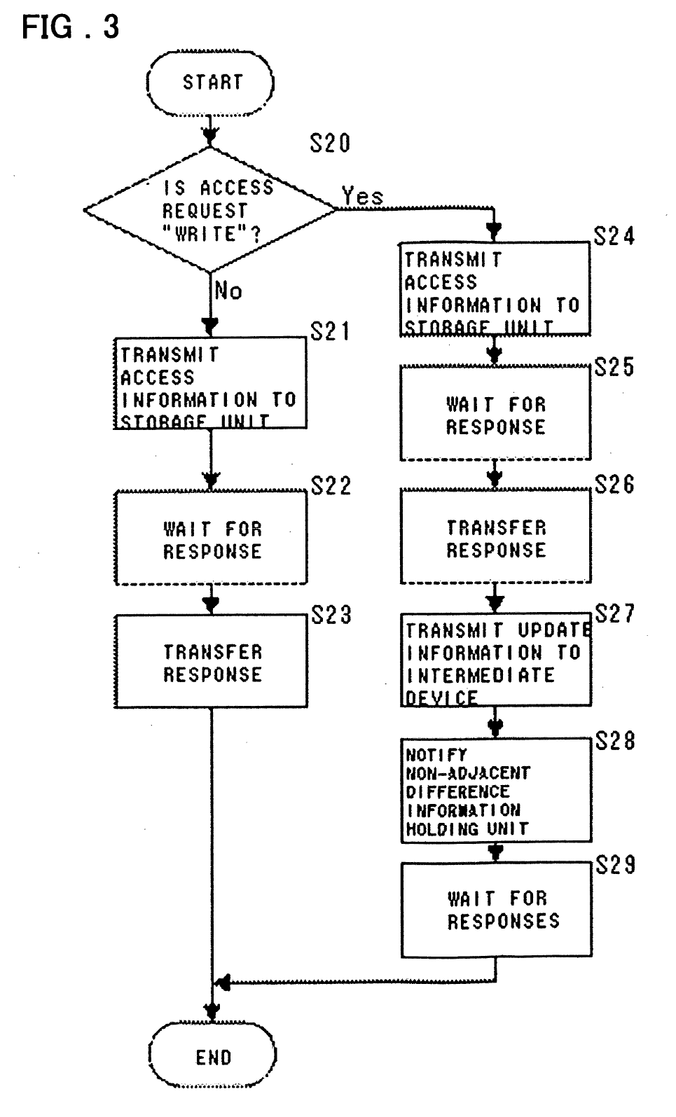

Next, reference will be had to FIG. 3 to describe operation when the replication master processing means 12 of this embodiment has received an access request from the host computer 11 in asynchronous replication.

Upon receiving the access request from the host computer 11, the replication master processing means 12 determines whether the access requested is “write” (step S20). Control proceeds to step S21 if the request is not “write” and to step S24 if the request is “write”.

At step S21 the replication master processing means 12 transfers the accepted access request to the normal storage unit 13 and waits for a response from the normal storage unit 13 (step S22).

When a response arrives at the replication master processing means 12, control proceeds to step S23 and the replication master processing means 12 transfers the response that has arrived to the host computer 11 and quits processing.

At step S24, the replication master processing means 12 transfers the accepted access request (write) to the normal storage unit 13 and waits for a response from the normal storage unit 13 (step S25).

When a response arrives at the replication master processing means 12, control proceeds to step S26 and the replication master processing means 12 transfers the response that has arrived to the host computer 11.

Next, the replication master processing means 12 creates update information from the access request and transmits the update information to the intermediate device 3 (step S27).

Next, the replication master processing means 12 creates update-related information from the update information and requests the non-adjacent difference information holding unit 16 to register the update-related information that has been created (notifies the non-adjacent difference information holding unit 16 of this information) (step S28).

Next, the replication master processing means 12 waits for responses from the intermediate device 3 and non-adjacent difference information holding unit 16 (step S29) and quits processing.

Update information includes the following:
information for specifying the write-target location and range;
the write-target data; and
an identifier for identifying the update information.

Update-related information includes the following:
information for specifying the write-target location and range; and
an identifier for identifying the update information.

The identifier for identifying the update information is generated by the replication master processing means 12.

Further, there are cases where the replication master processing means 12 generates update information from a plurality of access requests. In such cases the update information includes the following:

information for specifying a plurality of write-target locations and ranges;
a pair of write-target data; and
an identifier for identifying the update information.

Further, the update-related information includes:
information for specifying a plurality of write-target locations and ranges; and
an identifier for identifying the update information.

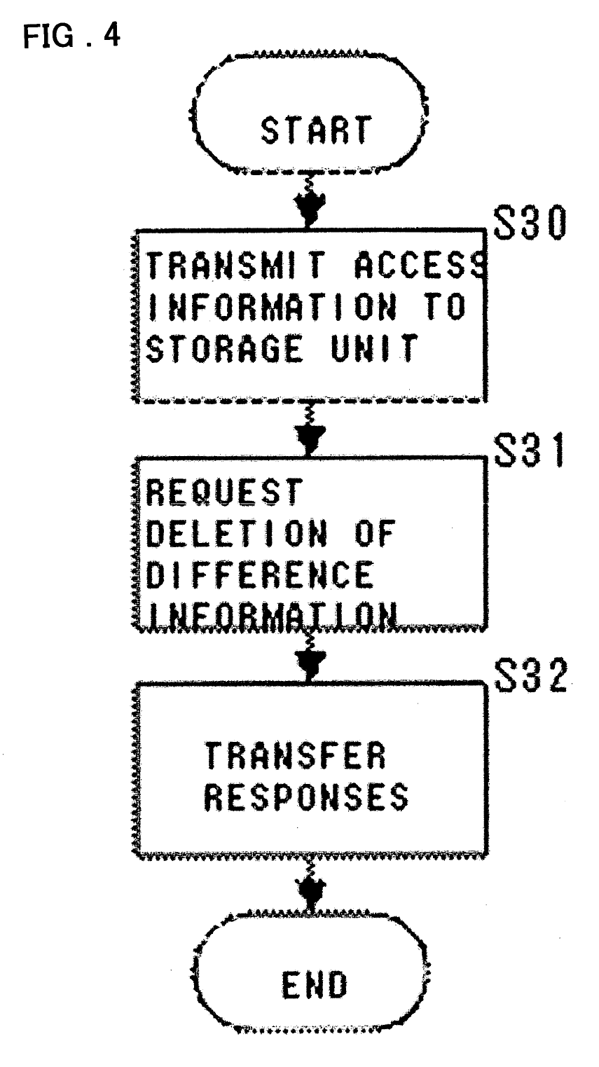

Next, reference will be had to FIG. 4 to describe operation when the replication replica processing means 14 of this embodiment has received update information from the intermediate device 3.

Upon receiving the update information from the intermediate device 3, the replication replica processing means 14 creates a write request from the update information and transmits an access request to the standby storage unit 15 (step S30).

Next, the replication replica processing means 14 creates update-completed information from the update information and requests the non-adjacent difference information holding unit 16 to delete the update information that corresponds to the update-completed information (step S31).

Next, the replication replica processing means 14 transmits a response to the intermediate device 3 (step 32) and quits processing.

It should be noted that, at step S32, the replication replica processing means 14 may wait for responses from the standby storage unit 15 and non-adjacent difference information holding unit 16 and transmit the responses to the intermediate device 3.

Further, there are cases where the replication replica processing means 14 creates a plurality of write requests from the sent update information at step S30.

Further, the update-completed information is an identifier, which is for identifying update information, contained in the update information. There are cases where the update-completed information includes identifiers contained in the update information for the purpose of identifying a plurality of items of update information.

Described next will be operation when the non-adjacent difference information holding unit 16 has accepted update-related information from the replication master processing means 12 of normal system 1 in the present embodiment.

Upon receiving update-related information from the replication master processing means 12, the non-adjacent difference information holding unit 16 records the update-related information in the storage device within the non-adjacent difference information holding unit 16.

It should be noted that in a case where content in the update-related information that agrees with that at the write-target location already exists in the storage device of the non-adjacent difference information holding unit 16, the non-adjacent difference information holding unit 16 may compare the two and leave only the newer update information. By adopting this expedient, it is possible to reduce the amount of use of the storage device in the non-adjacent difference information holding unit 16 and it is possible to implement the non-adjacent difference information holding unit 16 using a storage device having a smaller storage capacity.

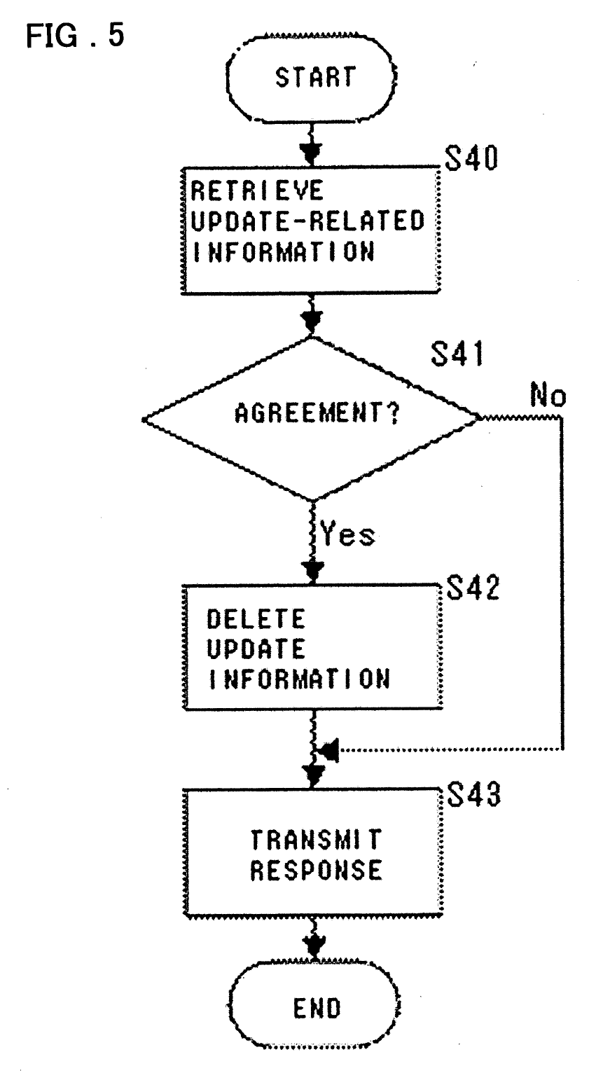

Next, reference will be had to FIG. 5 to describe operation when the non-adjacent difference information holding unit 16 has been requested to delete update information by the replication replica processing means 14 of the standby system 2.

Upon being requested to delete update information by the replication replica processing means 14, the non-adjacent difference information holding unit 16 searches its storage device for update information whose identifier agrees with an identifier for identifying the update information in the accepted update-completed information (step S40).

If update information whose identifier agrees with this specifying identifier has been recorded (“YES” at step S41), the non-adjacent difference information holding unit 16 advances processing to step S42; otherwise (“NO” at step S41), the non-adjacent difference information holding unit 16 advances processing to step S43.

At step S42, the non-adjacent difference information holding unit 16 deletes the update information found at step S41 from its storage device.

Next, at step S43, the non-adjacent difference information holding unit 16 transmits a response to the replication replica processing means 14 and quits processing.

In a case where a plurality of items of update information whose identifiers agree with the identifier for identifying the update information have been found at step S40, all of them are deleted at step S42.

Further, in a case where the update-completed information contains identifiers for identifying a plurality of items of update information, the processing of steps S40 to S42 is repeated a number of times equivalent to the number of identifiers.

The operation of the intermediate device 3 of this embodiment differs from that of an intermediate device of a serial-type information processing system as follows:

The intermediate device 3 of this embodiment is such that when update information is sent to the standby system 2, the information is caused to be held in the update information transmitted to the standby system without changing the identifier, which is for identifying the update information, contained in the update information that has been sent from the normal storage unit.

It should be noted that even in a case where the intermediate device 3 of this embodiment generates update-related information from a plurality of items of update information and transmits this information, the information is caused to be held in update information that transmits all identifiers without changing the identifiers, which are for identifying the update information, contained in the update information prior to generation.

Described next will be the operation of re-synchronization processing for placing the normal storage unit 13 and standby storage unit 15 in the synchronized state without the intermediary of the intermediate device 3 in the present embodiment.

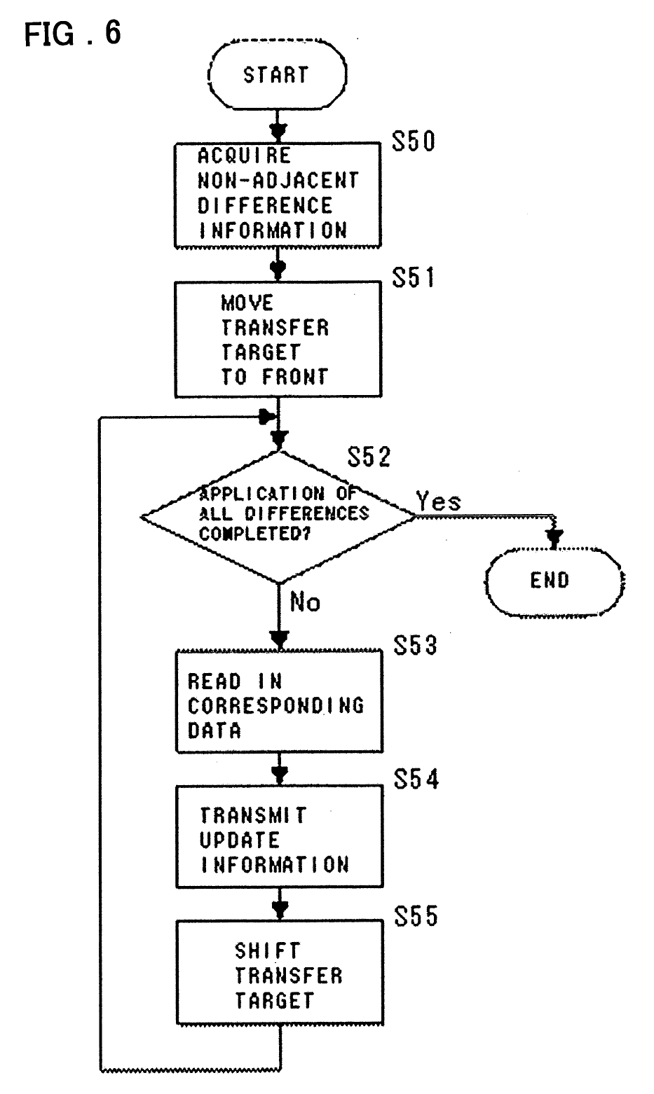

Reference will be had to FIG. 6 to describe operation of the replication master processing means 12 in re-synchronization processing according to this embodiment.

The replication master processing means 12 acquires update-related information not yet applied to the standby storage unit 15 from the non-adjacent difference information holding unit 16 in re-synchronization processing (step S50).

Next, the replication master processing means 12 selects one item of the acquired update-related information as a target (step S51).

The replication master processing means 12 determines whether unapplied update-related information remains (step S52). If unapplied update-related information remains (“YES” at step S52), control proceeds to step S53. If unapplied update-related information does not remain (“NO” at step S52), then processing is exited.

At step S53, the replication master processing means 12 acquires the write-target location and range from the target update-related information and reads in the data of this location and range from the normal storage unit 13.

Next, the replication master processing means 12 creates update information from the read-in data and the write-target location and range and transmits the update information to the standby system 2 as update information for re-synchronization purposes (step S54).

Next, the replication master processing means 12 makes update complete the update information that was the target, selects as a target the information that is not update complete from the update-related information acquired at step S50, and advances processing to step S52 (step S55).

It should be noted that it may be so arranged that the update information for re-synchronization is created from a plurality of write-target locations and ranges. Adopting this expedient makes it possible to reduce processing overhead for data transfer.

Described next will be operation when the replication replica processing means 14 has received update information for re-synchronization in the present embodiment. It should be noted that the update information for re-synchronization is transmitted from the replication master processing means 12 of normal system 1 to the replication replica processing means 14 of standby system 2 without the intermediary of the intermediate device 3.

Upon receiving the update information for re-synchronization from the normal system 1, the replication replica processing means 14 creates a write request from this re-synchronization update information, transmits an access request to the standby storage unit 15 and quits processing.

It should be noted that it may be so arranged that the replication replica processing means 14 transmits a response to the normal system 1 at the end of processing.

Further, the replication replica processing means 14 may transmit a response to the normal system 1 upon waiting for a response from the standby storage unit 15.

It may be so arranged that a plurality of write requests are created from update information sent from the normal system 1.

It should be noted that the operation of the host computer 11 in the present embodiment is the same as that of an ordinary computer, and that the operation of the normal storage unit 13 and standby storage unit 15 is the same as that of an ordinary storage unit.

The effects of this embodiment will be described next.

In this embodiment, update-related information from the normal system 1 is registered in the non-adjacent difference information holding unit 16, and the update-related information is deleted from the non-adjacent difference information holding unit 16 based upon update information accepted from the standby system 2. As a result, synchronization error between the normal storage unit 13 and the standby storage unit 15 can be recorded in the non-adjacent difference information holding unit 16.

Further, in the present embodiment, update information that arrives at the standby system 2 from the normal system 1 is made to possess an identifier for identifying update information that has been created by the normal system 1. This facilitates the retrieval and deletion of update-related information in the non-adjacent difference information holding unit 16.

Further, in the present embodiment, the non-adjacent difference information holding unit 16 is installed at a location different from that of the intermediate device 3. Even if the intermediate device 3 is lost, therefore, the non-adjacent difference information holding unit 16 can still be used. As a result, the normal storage unit 13 and the standby storage unit 15 will not become desynchronized even if the intermediate device 3 is lost.

Furthermore, in the present embodiment, synchronization error between the normal storage unit 13 and standby storage unit 15 can be recognized. As a result, when the normal storage unit 13 and standby storage unit 15 are directly re-synchronized, the normal storage unit 13 and standby storage unit 15 can be placed in the synchronized state by transferring only data in the storage unit that has undergone update.

In this embodiment, an arrangement may be adopted in which items of transmitted update information and received update information are held separately and difference information is created from both of these items of information when re-synchronization is performed.

Further, in the present embodiment, it may be so arranged that up to what point data was transmitted and up to what point data was received in the normal and standby systems is recorded and these items of data are joined together when necessary. Further, in the present embodiment, it may be so arranged that up to what point transmitted update information and received update information agree is verified and the information is then deleted in order to make it unnecessary to store difference information continuously.

A second embodiment of the present invention will now be described in detail with reference to the drawings. FIG. 7 is a block diagram illustrating the configuration of the second embodiment.

As shown in FIG. 7, the second embodiment includes the normal system 1, the standby system 2 and the intermediate device 3.

The normal system 1 has the host computer 11 for executing processing, the normal storage unit 13 for holding data, replication master processing means 20 for intervening in access to the normal storage unit 13 of the host computer 11 and executing replication processing on the side of the normal system 1, and an update information holding unit 22 in which the replication master processing means 20 registers update-related information.

The standby system 2 includes the standby storage unit 15 for holding data, replication replica processing means 21 for executing replication processing on the side of the standby system 2 and updating the data in the standby storage unit 15, and an update-completed information holding unit 23 in which the replication replica processing means 21 registers update-completed information.

The replication master processing means 20 of normal system 1 and the replication replica processing means 21 of standby system 2 are connected to the intermediate device 3 by a network, etc.

Further, the replication master processing means 20 of normal system 1 and the replication replica processing means 21 of standby system 2 are connected to each other by a network, etc.

The replication master processing means 20 of normal system 1 intervenes in access to the normal storage unit 13 of the host computer 11, executes replication processing on the side of the normal system 1 and registers update-related information concerning data update performed in the normal storage unit 13 in the update information holding unit 22. In a case where the normal storage unit 13 and standby storage unit 15 are placed in the synchronized state without the intermediary of the intermediate device 3, the replication master processing means 20 creates not yet reflected update information from update-completed information that has been acquired from the standby system 2, reads data out of the normal storage unit 13 and creates update information based upon the not yet reflected update information created, and transmits the re-synchronization update information to the replication replica processing means 21 of the standby system 2.

The replication replica processing means 21 of standby system 2 executes replication processing on the side of the standby system 2 based upon update information accepted from the intermediate device 3, and registers the received update information in the update-completed information holding unit 23. In a case where the normal storage unit 13 and standby storage unit 15 are placed in the synchronized state without the intermediary of the intermediate device 3, the replication replica processing means 21 updates the standby storage unit 15 based upon re-synchronization update information sent from the normal system 1.

The update information holding unit 22 has a storage device for storing update-related information. If update-related information has been accepted from the replication master processing means 20 of normal system 1, the update information holding unit 22 records this information. Further, upon receiving a request from the replication master processing means 20 of normal system 1, the update information holding unit 22 returns the recorded update-related information.

The update-completed information holding unit 23 has a storage device for storing update-completed information. If update-completed information has been accepted from the replication replica processing means 21 of standby system 2, the update-completed information holding unit 23 records this information. Upon receiving a request from the replication master processing means 20 of normal system 1, the update-completed information holding unit 23 returns the recorded update-completed information.

The host computer 11, normal storage unit 13, intermediate device 3 and standby storage unit 15 of this embodiment operate in the same manner as described in the first embodiment. Further, in the present embodiment, update information, update-related information, update-completed information and an identifier for identifying update information are the same as those of the first embodiment.

Operation involved in replication processing according to this embodiment will now be described.

Processing by the replication master processing means 20 in synchronous replication processing of this embodiment is the same as that of synchronous replication processing by the replication master processing means 12 of the first embodiment except for the fact that the destination of registration of the update-related information at step S15 in FIG. 2 is the update information holding unit 22.

Further, processing executed by the replication master processing means 20 in asynchronous replication processing of this embodiment is the same as that of asynchronous replication processing by the replication master processing means 12 of the first embodiment except for the fact that the destination of registration of the update-related information at step S28 in FIG. 3 is the update information holding unit 22.

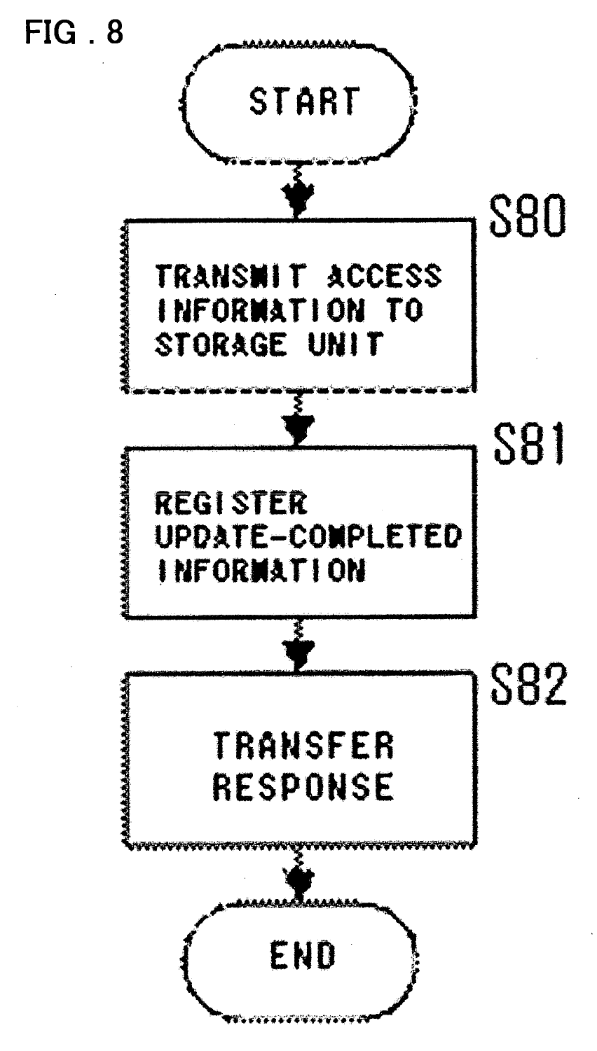

Reference will be had to FIG. 8 to describe operation when the replication replica processing means 21 has received update information from the intermediate device 3.

Upon receiving update information from the intermediate device 3, the replication replica processing means 21 creates a write request from the update information and transmits an access request to the standby storage unit 15 (step S80).

Next, the replication replica processing means 21 creates update-completed information from the update information and requests the update-completed information holding unit 23 to register the update-completed information (step S81).

Next, the replication replica processing means 21 transmits a response to the intermediate device 3 (step S82) and quits processing.

It may be so arranged that a response is transmitted to the intermediate device 3 upon waiting for responses from the standby storage unit 15 and update-completed information holding unit 23.

There are also cases where the replication replica processing means 21 creates a plurality of write requests from the sent update information at step S80.

Further, the update-completed information is an identifier, which is for identifying update information, contained in the update information. There are cases where update information includes identifiers for identifying a plurality of items of update information.

Described next will be operation when the update information holding unit 22 has accepted update-related information from the replication master processing means 20.

Upon receiving update-related information from the replication master processing means 20, the update information holding unit 22 records the update-related information in the storage device within the update information holding unit 22.

It should be noted that in a case where content in the update-related information that agrees with that at the write-target location already exists in the storage device of the update information holding unit 22, the update information holding unit 22 may compare the two and leave only the newer update information. By adopting this expedient, it is possible to reduce the amount of use of the storage device in the update information holding unit 22 and it is possible to implement the update information holding unit 22 using a storage device having a smaller storage capacity.

Described next will be operation when the update-completed information holding unit 23 has received update-completed information from the replication replica processing means 21.

Upon receiving update-completed information from the replication replica processing means 21, the update-completed information holding unit 23 records the update-completed information in its storage device.

With regard to a range in which identifiers for identifying update information in the update-completed information are continuous starting from the smallest identifier, it may be so arranged that the update-completed information holding unit 23 leaves only the identifier for identifying the newest update information and deletes those identifiers that are smaller than this identifier. By adopting this expedient, it is possible to reduce the amount of use of the storage device in the update-completed information holding unit 23 and it is possible to implement the update-completed information holding unit 23 using a storage device having a smaller storage capacity.

Described next will be the operation of re-synchronization processing for placing the normal storage unit 13 and standby storage unit 15 in the synchronized state without the intermediary of the intermediate device 3 in the present embodiment.

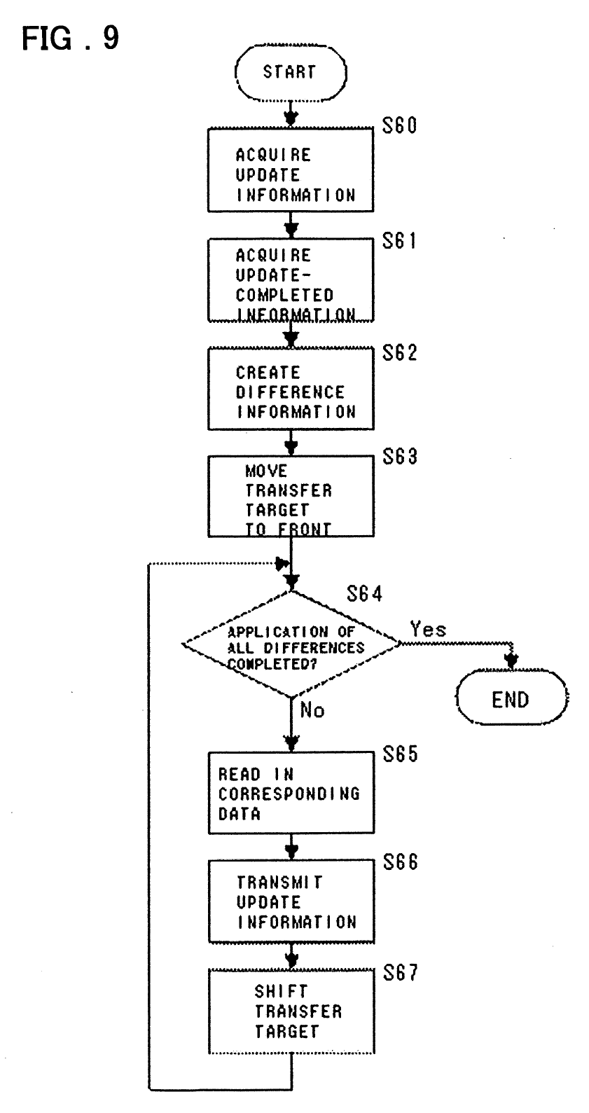

Reference will be had to FIG. 9 to describe operation of the replication master processing means 20 in re-synchronization processing in the present embodiment.

In re-synchronization processing, first the replication master processing means 20 acquires update-related information from the update information holding unit 22 (step S60).

Next, the replication master processing means 20 acquires update-completed information from the update-completed information holding unit 23 of standby system 2 (step S61).

Next, of the update-related information acquired at step S60, the replication master processing means 20 deletes that information whose identifier for identifying the update information agrees with the update-completed information acquired at step S61 and holds the remaining information as unapplied update-related information, which corresponds to the difference information between update performed in the normal storage unit 13 and update performed in the standby storage unit 15 (step S62).

Next, the replication master processing means 20 selects one item of the acquired update-related information as a transfer target (step S63). The item of the acquired update-related information selected as a transfer target is for example moved to the front for transmission.

Next, the replication master processing means 20 determines whether unapplied update-related information remains (step S64). If unapplied update-related information remains, control proceeds to step S65. If unapplied update-related information does not remain, then processing is exited.

At step S65, the replication master processing means 20 acquires the write-target location and range from the target update-related information and reads in the data of this location and range from the normal storage unit 13.

Next, the replication master processing means 20 creates update information from the read-in data and the write-target location and range and transmits the update information to the standby system 2 as update information for re-synchronization purposes (step S66).

Next, the replication master processing means 20 makes update complete the update information that was the target, selects as a target the information that is not update complete from the update-related information acquired at step S62, and advances processing to step S64 (step S67).

It should be noted that it may be so arranged that the update information for re-synchronization is created from a plurality of write-target locations and ranges. Adopting this expedient makes it possible to reduce processing overhead for data transfer.

If, in a case where the update-completed information recorded in the storage device of the update-completed information holding unit 23 is such that the identifiers for identifying the update information are continuous, the update-completed information holding unit 23 is so adapted as to record only the update information having the largest (latest) identifier, then, at step S62, update information whose identifier for identifying the update information in the update-related information is smaller (older) than the largest identifier for identifying the update information in the update-completed information in the continuous range is handled as being already applied.

In this embodiment, operation when the replication replica processing means 21 has received the re-synchronization update information is the same as operation when the replication replica processing means 14 of the first embodiment has received the re-synchronization update information except for the fact that the source of transmission of the re-synchronization update information is the replication master processing means 12 in the first embodiment.

The effects of this embodiment will be described next.

In accordance with this embodiment, update-related information of normal system 1 is held in the update information holding unit 22, update-completed information of standby system 2 is held in the update-completed information holding unit 23, and update information that has arrived at the standby system 2 from the normal system 1 is made to possess an identifier for identifying update information that has been created by the normal system 1. As a result, on the basis of the update-related information of the update information holding unit 22 and the update-completed information of the update-completed information holding unit 23, it is possible to create unapplied update information, which is update information that has not been transferred to the standby system 2.

In other words, in accordance with the present invention, synchronization error between the normal storage unit 13 and the standby storage unit 15 can be ascertained under conditions in which the intermediate device 3 does not matter.

Furthermore, in accordance with the present invention, the update information holding unit 22 and update-completed information holding unit 23 are installed at locations different from that of the intermediate device 3. Even if the intermediate device 3 is lost, therefore, synchronization error between the normal storage unit 13 and the standby storage unit 15 can be ascertained.

Furthermore, synchronization error between the normal storage unit 13 and standby storage unit 15 can be recognized. As a result, when the normal storage unit 13 and standby storage unit 15 are directly re-synchronized, the normal storage unit 13 and standby storage unit 15 can be placed in the synchronized state by transferring only data in the storage unit that has undergone update.

Furthermore, the normal storage unit 13 and standby storage unit 15 need only be connected to a relay device except when re-synchronization is performed, and it is unnecessary to hold a plurality of networks at all times.

In the first embodiment of the present invention illustrated in FIG. 1, the storage device possessed by the non-adjacent difference information holding unit 16 may be a memory, non-volatile memory, hard-disk drive or disk array, etc., although there is no particular limitation in this regard.

Further, in the first and second embodiments of the present invention, the normal storage unit 13 and standby storage unit 15 may each be a hard-disk drive, magnetic disk, optical disk, magneto-optical disk, magnetic tape, non-volatile memory or an array thereof, although there is no particular limitation in this regard.

It goes without saying that the normal storage unit 13 and standby storage unit 15 need not be devices of the same type.

It goes without saying that a plurality of host computers 11 may be provided in the first and second embodiments of the present invention.

The storage devices possessed by the update information holding unit 22 and update-completed information holding unit 23 in the second embodiment of the present invention may be a memory, non-volatile memory, hard-disk drive or disk array, etc., although there is no particular limitation in this regard.

The intermediate device 3 in the first and second embodiments of the present invention is a storage unit (hard-disk drive and disk-array device), a computer or a controller of a disk-array device having a function for receiving replication and a function for transmitting received update information.

In each of the foregoing embodiments, the intermediate device 3 may have a function for generating new update information from a plurality of items of received update information.

Further, the intermediate device 3 may hold complete replicated data of the normal storage unit.

In each of the foregoing embodiments, the intermediate device 3 may be a HA (high-availability) cluster system comprising a plurality of computers. Using such an intermediate device lowers the failure rate of the intermediate device and therefore improves the reliability of the entire serial-type information processing system.

Further, in each of the foregoing embodiments, it may be so arranged that difference information is recorded as an array as one example of a method of recording update-related information. For example, the update-related information recorded by the non-adjacent difference information holding unit 16 of FIG. 1, the update-related information recorded by the update information holding unit 22 of FIG. 7 and the update-completed information recorded by the update-completed information holding unit 23 may be recorded as an array of data in the storage devices of each of these means.

Alternatively, in each of the foregoing embodiments, it may be so arranged that difference information of the update-related information is recorded as a linear list. By adopting this expedient, reconstruction of the array need not be performed and processing by each of the aforesaid means can be reduced.

It may be so arranged that information indicating the leading position and range is used as information for specifying the write-target location included in the update-related information recorded by the non-adjacent difference information holding unit 16 of FIG. 1 and in the update-related information recorded by the update information holding unit 22 of FIG. 7.

The data storage area in the normal storage unit 13 and in the standby storage unit 15 may be logically divided into fixed-length or non-fixed-length areas (blocks), and an identification number (block number) of each block may be used as information for specifying the write-target location included in the update-related information. By adopting this expedient, the capacity prepared in order to record update-related information in the relevant means can be limited to the number of blocks in the normal storage unit 13 and standby storage unit 15.

Alternatively, for every block, difference information may be constituted in a form in which the sequence number of the final update is recorded.

Further, it may be so arranged that in a case where use is made of block numbers as mentioned above, update-related information recorded by the non-adjacent difference information holding unit 16 in the first embodiment and update-related information recorded by the update information holding unit 22 in the second embodiment is made an array that corresponds to the block number, and information having the latest (largest) identifier, which is for identifying update information when a block corresponding to this array has been updated, is recorded. In the case of such an arrangement, the data recorded as update-related information is only the identifier for identifying the update information. As a result, it is possible to reduce the capacity prepared in order to record the update-related information by the relevant means. Further, the time needed to retrieve update-related information in each of the means is shortened.

Further, processing whereby the non-adjacent difference information holding unit 16 in the first embodiment of the present invention deletes update-related information from the replication replica processing means 14 of the standby system 2 writes a value, which indicates completion of update, in a case where there is a match of identifiers for identifying update-related information of rows for which the block numbers in the array match.

Further, it may be so arranged that notification of update-completed information from the standby system 2 to he non-adjacent difference information holding unit 16 is sent once per number of times. Use is made of a configuration in which the frequency is, e.g., once per ten updates or once every second.

In the first embodiment of the present invention, in relation to processing when the replication replica processing means 14 has received update information from the intermediate device 3, it may be so arranged that communication (a request to register update information) to the non-adjacent difference information holding unit 16 at step S28 in FIG. 3 is performed once every number of times decided by the system or once in a period of time decided by the system. By adopting this expedient, it is possible to reduce communication load between the standby system 2 and non-adjacent difference information holding unit 16.

It may be so arranged that a difference map held by the non-adjacent difference information holding unit 16 is made a plurality of difference maps that have recorded whether or not an update has been made block by block, and the difference map is changed over every number of update sequences and a difference map is deleted when all update-completed information has been delivered in this period of time. A set of flags (a difference map) that corresponds to each block in a plurality of normal storage units 13 may be adopted to implement a method of recording update-related information in the non-adjacent difference information holding unit 16 of the first embodiment of the invention.

The difference map that records the update-related information is changed over every number of times decided by the system or at time intervals decided by the system.

At this time an identifier for identifying update-related information is recorded in management information of the difference map. When the non-adjacent difference information holding unit 16 has received update-related information from the replication master processing means 12 of normal system 1, a flag corresponding to a block specified by the update-related information in the difference map effective at this time is set.

Furthermore, when the non-adjacent difference information holding unit 16 has been requested to delete update information from the replication replica processing means 14 of standby system 2, an identifier for identifying update-related information in the update-completed information is deleted from the management information of this difference map.

In a case where there is no longer an identifier for identifying update-related information in management information of a difference map, this difference map is invalidated.

Further, in the re-synchronization processing (step S50 in FIG. 6) of the replication master processing means 12, the logical sum of valid difference maps in the non-adjacent difference information holding unit 16 is obtained and a block for which a flag has been set is delivered to the replication master processing means 12 as unapplied update-related information. By adopting this expedient, the difference map will be such that one flag suffices for each block. This makes it possible to reduce capacity prepared in order to record the update-related information of the non-adjacent difference information holding unit 16.

The non-adjacent difference information holding unit 16 may be placed in the normal system 1.

In the first embodiment, the non-adjacent difference information holding unit 16 does not belong to the normal system 1 or standby system 2, but it may be included in the normal system 1. By adopting this expedient, a delay in communication between the replication master processing means 12 and non-adjacent difference information holding unit 16 is shortened and there is an increase in the speed of replication processing by the normal system 1 and in the speed of re-synchronization processing. Further, by raising the speed of re-synchronization processing, periods in which the normal storage unit and standby storage unit are not in synchronization are shortened and periods in which system reliability diminishes can be shortened further.

The non-adjacent difference information holding unit 16 may be constructed as part of the replication master processing means 12 of normal system 1. Adopting this expedient eliminates a delay in communication in an operation that requires communication with the non-adjacent difference information holding unit 16 in the replication master processing means 12 and raises the speed of replication processing by the normal system 1 and the speed of re-synchronization processing. Further, by raising the speed of re-synchronization processing, periods in which the normal storage unit and standby storage unit are not in synchronization are shortened and periods in which system reliability diminishes can be shortened further.

The update information holding unit 22 of the second embodiment of the invention may be made part of the replication master processing means 20. Adopting this expedient eliminates a delay in communication in an operation that requires communication with the update information holding unit 22 in the replication master processing means 20 and raises the speed of replication processing by the normal system 1 and the speed of re-synchronization processing.

In the second embodiment, the update-completed information holding unit 23 may be made part of the replication replica processing means 21. Adopting this expedient eliminates a delay in communication in an operation that requires communication with the update-completed information holding unit 23 in the replication replica processing means 21 and raises the speed of replication processing in the standby system 2.

The replication master processing means 12 in the first embodiment and the replication master processing means 20 in the second embodiment of the invention are provided between the host computer 11 and the normal storage unit 13. However, the invention is not limited to such an arrangement and these may be made part of the host computer 11 or part of the normal storage unit 13.

Although the replication replica processing means 14 in the first embodiment and the replication replica processing means 21 in the second embodiment of the invention are placed outside the standby storage unit 15, these may be made part of the standby storage unit 15.

Alternatively, it may be so arranged that a plurality of intermediate devices are placed between the normal system 1 and the standby system 2.

Further, the intermediate device is a storage device and the normal storage unit and intermediate device are mirrors. If a plurality of intermediate devices are provided, re-synchronization can be achieved between the normal channel or an N-th intermediate device and the standby channel or an (N+2)th intermediate device, which is not directly connected, that brackets one or more intermediately devices between itself and the Nth intermediate device.

The present invention is applicable to a serial information processing system. Further, the invention is applicable to a robustly disaster-resistant information system that employs serial replication.

Though the present invention has been described in accordance with the foregoing embodiments, the invention is not limited to this embodiment and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An information processing system comprising:
first and second systems, each including a storage unit, replication being performed from said first system to said second system via an intermediate device; and
a difference information holding unit for holding difference information between an update performed in the storage unit of said first system and an update performed in the storage unit of said second system.

2. The information processing system according to claim 1, wherein said difference information held in said difference information holding unit includes information which is for specifying an update not yet reflected to the storage unit of said second system from among updates performed in the storage unit of said first system.

3. The information processing system according to claim 1, wherein when update information is transmitted from said first system to said second system in relation to an update performed with respect to the storage unit of said first system, said difference information holding unit registers update-related information that corresponds to said update information; and when said second system has received said update information, said difference information holding unit deletes the update-related information corresponding to said update information from registered update-related information.

4. The information processing system according to claim 1, wherein data re-synchronization between the storage unit of said first and the storage unit of said second system is performed based upon the difference information recorded in said difference information holding unit.

5. The information processing system according to claim 1, comprising said intermediate device, said intermediate device receiving update information sent from said first system and transferring said update information to said second system.

6. The information processing system according to claim 1, wherein said difference information holding unit transfers update data, which has been updated in the storage unit of said first system and is not yet reflected to the storage unit of said second system, from said first system to said second system, based upon the difference information held in said difference information holding unit;
said second system receives the not yet reflected update data transferred from said difference information holding unit and applies the not yet reflected update data to the storage unit of said second system; and
said first system and said second system are capable of being restored to a synchronized state even in the event of failure or loss of the intermediate device.

7. The information processing system according to claim 6, wherein in processing for being restoring to the synchronized state in the event of failure or loss of the intermediate device, the not yet reflected update information is transferred from said first system to said second system without the intermediary of the intermediate device.

8. The information processing system according to claim 1, further comprising means for appending identification information for identifying a corresponding relationship between update information received by said second system and update information transmitted from said first system, to the update information received by said second system.

9. The information processing system according to claim 1, wherein when update information is transmitted from said first system to the intermediate device in relation to an update performed with respect to the storage unit of said first system, update-related information that corresponds to this update information is recorded in said difference information holding unit; and
when said second system has received the update information from the intermediate device, update-related information corresponding to this update information is deleted from said difference information holding unit.

10. An information processing system comprising:
a first system having a storage unit, an intermediate device;
a second system having a storage unit;
replication being performed from said first system to said second system via said intermediate device;
an update information holding unit for recording an update performed in the storage unit of said first system; and
an update-completed information holding unit for recording an update, received by said second system from said intermediate device and reflected to the storage unit of said second system.

11. The information processing system according to claim 10, wherein a corresponding relationship between update-related information recorded in said update information holding unit and update-completed information recorded by said update-completed information holding unit is made determinable.

12. The information processing system according to claim 10, wherein re-synchronization of data between said first and second systems is performed based upon information, which concerns data synchronization error, generated from the update-related information recorded in said update information holding unit of said first system and the update-completed information recorded in said update-completed information holding unit of said second system.

13. The information processing system according to claim 1, further comprising means for making discriminatable a corresponding relationship between update information sent from said first system and update information received by said second system.

14. The information processing system according to claim 13, wherein update information that has not yet arrived at said second system is made specifiable from update information transmitted by said first system and update information received by said second system.

15. The information processing system according to claim 13, wherein data re-synchronization between said first system and said second system is performed by re-sending update information transmitted from said first system to said intermediate device and not received by said second system.

16. The information processing system according to claim 1, wherein update data which has been applied to the storage unit of said first system and is not yet reflected to the storage unit of said second system is transferred from said first system to said second system, based upon said difference information held in said difference information holding unit, when said intermediate device has failed or been lost; and
said second system, upon receiving the not yet reflected update data transferred, applies the not yet reflected update to the storage unit of said second system.

17. The information processing system according to claim 10, wherein
said first system includes said update information holding unit; and
said second system includes said update-completed information holding unit; and wherein
said information processing system further comprises means for comparing contents held by said update information holding unit and said update-completed information holding unit, when said intermediate device has failed or been lost, computing update content, which is not yet reflected to the storage unit of said second system, among updates performed in the storage unit of said first system, and transferring the computed update content from said first system to said second system;
said second system applying the transferred not yet reflected update data to the storage unit of said second system.

18. The information processing system according to claim 17, wherein identification information for ascertaining correspondence between update information sent from said first system to said second system via said intermediate device and update information sent by said first system is appended to the update information sent to said second system, and an update recorded in said first difference information holding unit and an update recorded in said second difference information holding unit are capable of being correlated.

19. A difference information holding apparatus provided in an information processing system including a first system having a storage unit, an intermediate device and a second system having a storage unit, wherein replication is performed from said first system to said second system via said intermediate device, the apparatus comprising:
means for holding difference information between an update performed in the storage unit of said first system and an update performed in the storage unit of said second system; and
means for transferring update information that is not yet reflected to the storage unit of said second system to said second system, from among updates performed in the storage unit of said first system, based upon the held difference information when said intermediate device fails or is lost.

20. A replication method in an information processing system in which replication is performed from a first system having a storage unit to a second system having a storage unit, said method comprising the steps of:
when update information is transmitted from said first system to said second system in relation to an update performed with respect to the storage unit of said first system, registering update-related information corresponding to said update information in a difference information holding unit; and
when said second system has received said update information, deleting the update-related information corresponding to said update information from update-related information registered in said difference information holding unit, thereby difference information between update performed in said storage unit of said first system and update performed in said storage unit of said second system being recorded in said difference information holding unit.

21. The method according to claim 20, further comprising a step of performing data re-synchronization between the storage unit of said first and the storage unit of said second system based upon the difference information recorded in said difference information holding unit.

22. The method according to claim 20, further comprising the steps of:
said difference information holding unit transferring updated data, which has been applied to the storage unit of said first system and not yet reflected to the storage unit of said second system, to said second system based upon the difference information held in said difference information holding unit; and
applying the not yet reflected update data transferred to said second system to the storage unit of said second system;
said first system and said second system being capable of being restored to a synchronized state even in the event of failure or loss of the intermediate device.

23. The method according to claim 20, wherein identification information, which identifies a corresponding relationship between update information received by said second system and update information transmitted from said first system, to the update information received by said second system.

24. The method according to claim 20, wherein when update information is transmitted from said first system to the intermediate device in relation to an update performed with respect to the storage unit of said first system, recording update-related information that corresponds to said update information in said difference information holding unit; and when said second system has received the update information from the intermediate device, deleting update-related information corresponding to said update information from said difference information holding unit.

25. A replication method in an information processing system including a first system having a storage unit, an intermediate device and a second system having a storage unit, wherein replication is performed from said first system to said second system via said intermediate device, said method comprising the steps of:
recording an update, performed in the storage unit of said first system, in an update information holding unit; and
recording an update, sent from said intermediate device and reflected to the storage unit of said second system, in an update-completed information holding unit.

26. The method according to claim 25, further comprising a step of performing re-synchronization of data between said first and second systems based upon information, which concerns data synchronization error, generated from the update-related information recorded in said update information holding unit and the update-completed information that recorded in said update-completed information holding unit.

27. The method according to claim 26, wherein a corresponding relationship between update-related information recorded in said update information holding unit and update-completed information recorded by said update-completed information holding unit is made freely determinable.

28. A computer program for causing a computer to execute the following processing, the computer constituting a difference information holding apparatus provided in an information processing system including a first system having a storage unit, an intermediate device and a second system having a storage unit, wherein replication is performed from said first system to said second system via said intermediate device:
processing for holding difference information between an update performed in the storage unit of said first system and an update performed in the storage unit of said second system; and
processing for transferring update information that is not yet reflected to the storage unit of said second system, from among updates performed in the storage unit of said first system, to said first system based upon the held difference information when said intermediate device fails or is lost.
